(19) United States
(12) Patent Application Publication
(10) Pub. No.: US 2026/0117841 A1
(43) Pub. Date: Apr. 30, 2026

(54) VARIABLE-STIFFNESS MECHANISM BASED ON COMPLIANT BEAMS

(71) Applicant: NUtech Ventures, Lincoln, NE (US)

(72) Inventors: Carl A. Nelson, Lincoln, NE (US); Benjamin L. Zwiener, Lincoln, NE (US)

(21) Appl. No.: 19/356,550

(22) Filed: Oct. 13, 2025

Related U.S. Application Data
(60) Provisional application No. 63/713,880, filed on Oct. 30, 2024.

(51) Int. Cl. F16F 15/121; F16F 15/12

(52) U.S. Cl. CPC F16F 15/1215; F16F 15/1205; F16F 15/1206; F16F 15/1207; F16F 2228/066; F16F 2232/02

(57) ABSTRACT

A variable-stiffness mechanism may be based on compliant beams. The variable-stiffness mechanism may be a compact, compliant, variable stiffness mechanism (CCVSM). Several compliant mechanisms for integrating variable-stiffness are described. The variable-stiffness mechanisms may be based on a compliant beam configuration, a crank-slider configuration, and/or a gear-slider configuration. Relative merits of the variable-stiffness mechanisms are also compared.

### CROSS-REFERENCE

The present application claims the benefit under 35 U.S.C. § 119 (e) of U.S. Provisional Application Ser. No. 63/713,880, filed Oct. 30, 2024, titled “VARIABLE-STIFFNESS MECHANISM BASED ON COMPLIANT BEAMS”, which is incorporated herein by reference in the entirety.

### TECHNICAL FIELD

The present disclosure generally relates to manipulators, and more particularly to actuating means with variable stiffness.

### BACKGROUND

Industrial robots are ubiquitous in the manufacturing industry due to high accuracy, dexterity, repeatability, and efficiency. Heavy and extensive use of the industrial robots may cause significant wear to the robot. Notably, the large accelerations involved in performing high-speed motions can cause considerable wear on the robot through peak torques, high peak energy demands, and associated mechanical loads. The large accelerations may also necessitate higher-performance actuators to tolerate the peak loads. Additionally, more maintenance, loss of production time, spare parts, and excessive energy all add to the cost of implementing, owning, and operating robots in modern industry.

Variable stiffness mechanisms (VSMs) or variable stiffness actuators (VSAs) are an area of research within the field of robotics. VSMs are mechanical or mechatronic devices which change the stiffness within a joint or an actuator system via mechanical principles. The variable stiffness may be achieved through at least three different principles: varying the preload of a spring, varying the transmission ratio between output and spring, or varying the physical properties of the spring. Many popular mechanisms in this field of mechanics have been developed for the purpose of reducing wear in rotational joints of robotic systems. Some mechanism achieve the variable stiffness through the variable lever principle. Other mechanisms, achieve the variable stiffness by varying the preloaded spring.

Variable-stiffness mechanisms have traditionally been designed to act at a specific robotic joint (rotational or linear) to vary the component stiffness at that point in the kinematic structure. This couples the effective stiffness at the end effector (the tool carried by the robot) to both the joint-level component stiffness(es) and the robot's inherent kinematic characteristics (represented by the Jacobian matrix, and dependent on the positioning of the robot).

While VSMs offer advantages, their inherent designs can have drawbacks. VSMs are generally more complicated mechanisms than standalone robotic joints. For example, VSMs may also require more components and complex design than the standalone robotic joints. VSMs may also be tedious to manufacture and overall laborious to implement. Higher part counts typically leads to increased cost, size, and weight, which contradict the enhanced performances of the VSM. A reduction in these limitations is sought to make VSMs a more accessible solution.

Compliant mechanisms may solve many of the obstacles of current VSMs. Like a rigid body mechanism, a compliant mechanism transmits energy to do useful work; however, the compliant nature of the compliant mechanism allows for some of that energy to be stored through its deflection, all while performing the mechanical function of a traditional rigid-body mechanism. As components of a compliant mechanism are intended to move, different materials and structure enable simpler manufacturing techniques which lead to reduced parts count, assembly time, cost, weight, and maintenance. While prone to other disadvantages such as fatigue, lack of full rotational motion, and nonlinear mechanical behavior, they can often be designed to overcome these issues.

Therefore, it would be advantageous to provide a device, system, and method that cures the shortcomings described above.

### SUMMARY

A variable-stiffness mechanism is described, in accordance with one or more embodiments of the present disclosure. The variable-stiffness mechanism may include: a first unit; a second unit, wherein the second unit includes an outer-annular portion and a plurality of contact portions, wherein the plurality of contact portions are disposed radially inwards of and axially aligned with the outer-annular portion; and a compliant member, wherein the compliant member is fixed to the first unit, wherein the compliant member is disposed radially inwards of and axially aligned with the second unit, wherein the compliant member includes a plurality of arc-segment portions, wherein the plurality of arc-segment portions are cantilever beams, wherein the plurality of contact portions abut the plurality of arc-segment portions, wherein the second unit is configured to rotate relative to the first unit and the compliant member, wherein the plurality of contact portions maintain abutment with the plurality of arc-segment portions as the second unit rotates relative to the first unit and the compliant member, wherein a stiffness of the variable-stiffness mechanism is varied based on a circumferential position at which the plurality of contact portions abut the plurality of arc-segment portions.

A variable-stiffness mechanism is described, in accordance with one or more embodiments of the present disclosure. The variable-stiffness mechanism may include: a first unit, wherein the first unit defines a plurality of slotted arcs; a second unit, wherein the second unit is configured to rotate relative to the first unit; and a plurality of crank-slider subassemblies, wherein the second unit is disposed radially inwards of and axially aligned with the plurality of crank-slider subassemblies, wherein the plurality of crank-slider subassemblies include: a compliant member, wherein the compliant member abuts the second unit; an input crank, wherein the input crank is coupled to the first unit by a revolute joint; a pair of connecting rods; a pair of rod-to-member revolute joints, wherein the compliant member is coupled to the pair of connecting rods by the pair of rod-to-member revolute joints; and a pair of crank-to-rod revolute joints, wherein the pair of connecting rods are coupled to the input crank by the pair of crank-to-rod revolute joints, wherein the pair of crank-to-rod revolute joints are configured to follow within the plurality of slotted arcs, wherein a circumferential center of the compliant member to which the second unit abuts is configured to flex radially inwards and outwards as the pair of crank-to-rod revolute joints follow within the plurality of slotted arcs, wherein a stiffness of the variable-stiffness mechanism is varied based on flexure of the compliant member.

A variable-stiffness mechanism is described, in accordance with one or more embodiments of the present disclosure. The variable-stiffness mechanism may include: a first unit; a second unit, wherein the second unit is configured to rotate relative to the first unit, wherein the second unit is annular; a planetary gearset, wherein the planetary gearset is disposed radially inwards of and axially aligned with the second unit, wherein the planetary gearset includes: a sun gear, wherein the sun gear is configured to rotate relative to the first unit; a plurality of planet gears, wherein the plurality of planet gears are coupled to the first unit by a plurality of unit-to-planet revolute joints, wherein the sun gear engages with the plurality of planet gears; a plurality of ring-gear segments, wherein the plurality of planet gears engage with respective of the plurality of ring-gear segments; and a plurality of compliant members, wherein the plurality of compliant members are coupled to and revolve with respective of the plurality of ring-gear segments about the sun gear, wherein the plurality of compliant members include: an arc-segment portion, wherein the arc-segment portion couples to the plurality of ring-gear segments; and a contact portion, wherein the contact portion extends radially from the arc-segment portion and abuts the second unit; and a plurality of pivot pins fixed to the first unit, wherein the plurality of pivot pins and the plurality of ring-gear segments are radially aligned, wherein the arc-segment portion of the plurality of compliant members abut and pivot about the plurality of pivot pins, wherein a stiffness of the variable-stiffness mechanism is varied based on a circumferential position at which the plurality of pivot pins abut the arc-segment portion of the plurality of compliant members.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the description and drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1 illustrates a block diagram of a system including a variable-stiffness mechanism, in accordance with one or more embodiments of the present disclosure.

FIG. 2A illustrates a perspective view of a variable-stiffness mechanism configured as a cantilever-beam variable-stiffness mechanism in a least stiff configuration with a second unit abutting at unsupported ends of arc-segment portions of a compliant member, in accordance with one or more embodiments of the present disclosure.

FIG. 2B illustrates a perspective view of the variable-stiffness mechanism configured as the cantilever-beam variable-stiffness mechanism in a stiffest configuration with the second unit abutting at supported ends of arc-segment portions of the compliant member, in accordance with one or more embodiments of the present disclosure.

FIG. 2C illustrates a perspective view of the compliant member, in accordance with one or more embodiments of the present disclosure.

FIG. 3A illustrates a perspective view of the variable-stiffness mechanism configured as the cantilever-beam variable-stiffness mechanism in the least stiff configuration with the second unit abutting at unsupported ends of arc-segment portions of the compliant member, in accordance with one or more embodiments of the present disclosure.

FIG. 3B illustrates a perspective view of the variable-stiffness mechanism configured as the cantilever-beam variable-stiffness mechanism in the stiffest configuration with the second unit abutting at supported ends of arc-segment portions of the compliant member, in accordance with one or more embodiments of the present disclosure.

FIG. 4 illustrates a perspective view of a variable-stiffness mechanism configured as a crank-slider variable-stiffness mechanism, in accordance with one or more embodiments of the present disclosure.

FIG. 5A illustrates a perspective view of a variable-stiffness mechanism configured as a gear-slider variable-stiffness mechanism in a least stiff configuration, in accordance with one or more embodiments of the present disclosure.

FIG. 5B illustrates a perspective view of the variable-stiffness mechanism configured as the gear-slider variable-stiffness mechanism in the stiffest configuration, in accordance with one or more embodiments of the present disclosure.

FIG. 5C illustrates a perspective view of the variable-stiffness mechanism configured as the gear-slider variable-stiffness mechanism with ring-gear segments and connecting segments forming a ring gear, in accordance with one or more embodiments of the present disclosure.

FIG. 6A illustrates a top view of a variable-stiffness mechanism configured as the cantilever-beam variable-stiffness mechanism with spiral-shaped arc-segment portions, in accordance with one or more embodiments of the present disclosure.

FIG. 6B illustrates a top view of a variable-stiffness mechanism configured as the cantilever-beam variable-stiffness mechanism with circular-shaped arc-segment portions, in accordance with one or more embodiments of the present disclosure.

FIG. 6C illustrates a top view of a variable-stiffness mechanism configured as the crank-slider with a crank-slider assembly which is partially disassembled, in accordance with one or more embodiments of the present disclosure.

FIG. 6D illustrates a top view of a variable-stiffness mechanism configured as the gear-slider, in accordance with one or more embodiments of the present disclosure.

FIG. 7 illustrates a graph of torsional stiffness as a function of an effective beam length of the variable-stiffness mechanism, in accordance with one or more embodiments of the present disclosure.

FIG. 8A illustrates simulations of the variable-stiffness mechanism with the spiral-shaped arc-segment portions, in accordance with one or more embodiments of the present disclosure.

FIG. 8B illustrates simulations of the variable-stiffness mechanism with the circular-shaped arc-segment portions, in accordance with one or more embodiments of the present disclosure.

FIG. 8C illustrates simulations of the variable-stiffness mechanism configured as the crank-slider, in accordance with one or more embodiments of the present disclosure.

FIG. 9 illustrates a graph of stiffness as a function of effective beam length of the variable-stiffness mechanisms, in accordance with one or more embodiments of the present disclosure.

FIG. 10 illustrates graphs of torsional stiffness as a function of effective beam length in meters of the variable-stiffness mechanisms, in accordance with one or more embodiments of the present disclosure.

### DETAILED DESCRIPTION OF THE INVENTION

The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure. Reference will now be made in detail to the subject matter disclosed, which is illustrated in the accompanying drawings.

Embodiments of the present disclosure are directed to a variable-stiffness mechanism based on compliant beams. The variable-stiffness mechanism may be a compact, compliant, variable stiffness mechanism (CCVSM). Several compliant mechanisms for integrating variable-stiffness are described. The variable-stiffness mechanisms may be based on a compliant beam configuration, a crank-slider configuration, and/or a gear-slider configuration. Relative merits of the variable-stiffness mechanisms are also compared.

The range of purposes of the variable-stiffness mechanisms includes varying the stiffness while experiencing constant position or load, and absorption of sudden loads during highly dynamic movements. The variable-stiffness mechanisms may provide a supplemental solution to save energy and reduce wear for various applications, such as industrial robots. The variable-stiffness mechanisms may include in-flight tunable stiffness to optimize for applications where precision or flexibility are desired. The variable-stiffness mechanisms provide repeatability and a mechanical safeguard between the robot arm and its end effector (EE). Specifically, the variable-stiffness mechanisms may provide a compact and simple design which allows customizable stiffness in the x-y plane to support the needs of industrial pick-and-place operations, with the intent of further extending this work to include z-axis stiffness adjustment. The variable-stiffness mechanisms may integrate multiple degrees of freedom in a single device at the end effector.

Variable-stiffness mechanisms are described that use compliant members and the concept of effective lever/beam length to adjust the output stiffness to a robotic end effector. The compliant members may allow for “in-flight” stiffness adjustment. The variable-stiffness mechanism may provide variable stiffness at the end effector and may provide controlled stiffness variation in the cardinal directions (e.g., x/y/z Cartesian directions for a 3-degree-of-freedom robot). The variable-stiffness mechanism may use compliant beams as the source of stiffness variation, and vary the contact point of the load from the end effector on these beams to change the apparent stiffness.

U.S. patent application U.S. Pat. No. 11,192,266B2, titled “Variable stiffness series elastic actuator”, is incorporated herein by reference in the entirety.

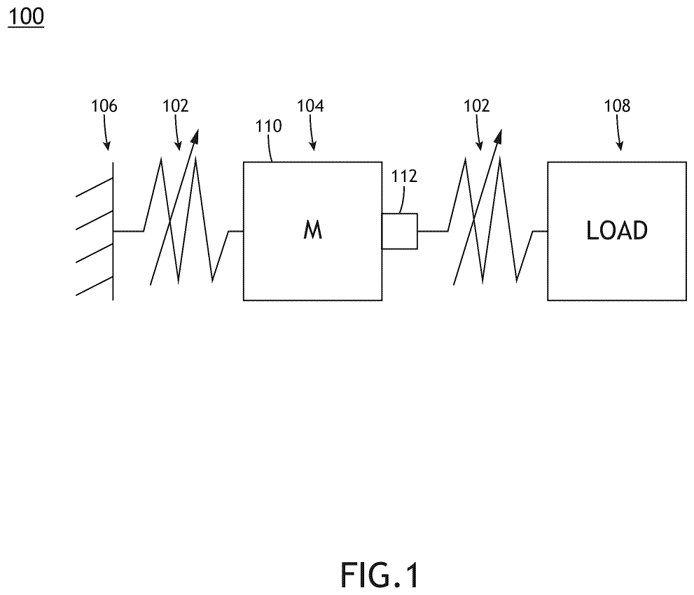

FIG. 1 illustrates a simplified block diagram of a system 100, in accordance with one or more embodiments of the present disclosure. The system 100 may include a variable-stiffness mechanism 102, an actuator 104, a local ground 106, and/or a load path 108.

The variable-stiffness mechanism 102 may couple between the actuator 104 and the local ground 106. The variable-stiffness mechanism 102 may be located upstream of the actuator 104 in the load path 108 by coupling between the actuator 104 and the local ground 106. One advantage of coupling the variable-stiffness mechanism 102 between the actuator 104 and the local ground 106 is that the stiffness adjustment by the variable-stiffness mechanism 102 may be actuated locally, independent of a nominal position of the actuator 104.

The variable-stiffness mechanism 102 may also couple between the actuator 104 and the load path 108. The variable-stiffness mechanism 102 may be located downstream of the actuator 104 by coupling between the actuator 104 and the load path 108. One advantage of coupling the variable-stiffness mechanism 102 between the actuator 104 and the load path 108 is that the stiffness variation by the variable-stiffness mechanism 102 may be within an end effector of the actuator 104.

The actuator 104 may be a motor, a main actuator, or the like. The actuator 104 may be a rotary actuator. The actuator 104 may include a stator 110 and/or a rotor 112. The rotor 112 may be configured to rotate relative to the stator 110. The rotor 112 may couple to the load path 108 by which the rotor 112 is configured to rotate the load path 108. Since the variable-stiffness mechanism 102 is upstream of the actuator 104, the system 100 may permit continuous rotation of the rotor 112.

The variable-stiffness mechanism 102 may receive a primary torque (TM) from the actuator 104. The primary torque (TM) may be generated by the actuator 104 in response to turning and/or stopping the rotor 112. The variable-stiffness mechanism 102 may couple the primary torque (TM) into the local ground 106. The local ground 106 may be a mounting point which receives the primary torque (TM).

The variable-stiffness mechanism 102 may include a stiffness. The stiffness may control the coupling of the primary torque (TM) into the local ground 106. The variable-stiffness mechanism 102 may be configured to vary the stiffness such that the stiffness is variable and/or tunable. The variable-stiffness mechanism 102 may provide a higher compliance and/or a lower stiffness which allows for more energy efficient applications by decreasing loads on the actuator 104. The variable-stiffness mechanism 102 may allow the actuator 104 to perform tasks that would exceed a critical load threshold of the variable-stiffness mechanism 102 thus preventing breakage.

In embodiments, the actuator 104 may be an end effector of a robot and the local ground 106 may be an arm of the robot.

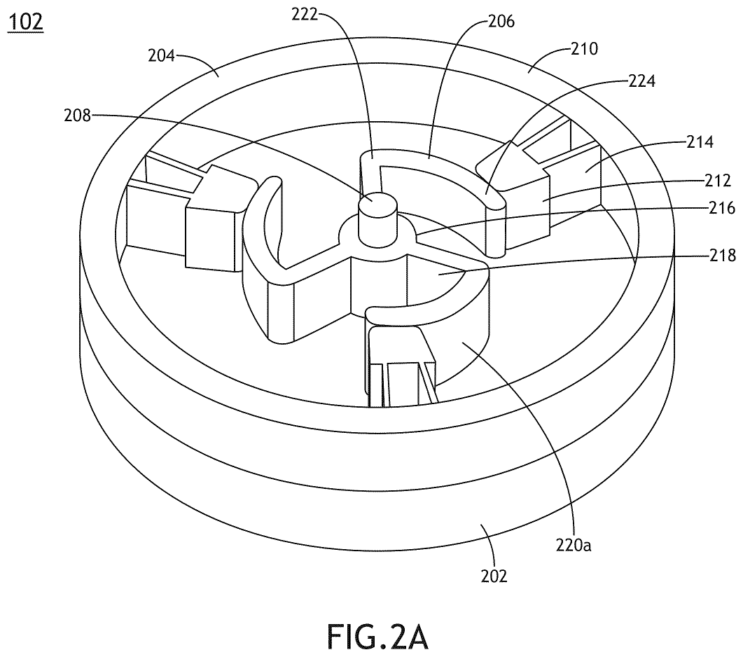

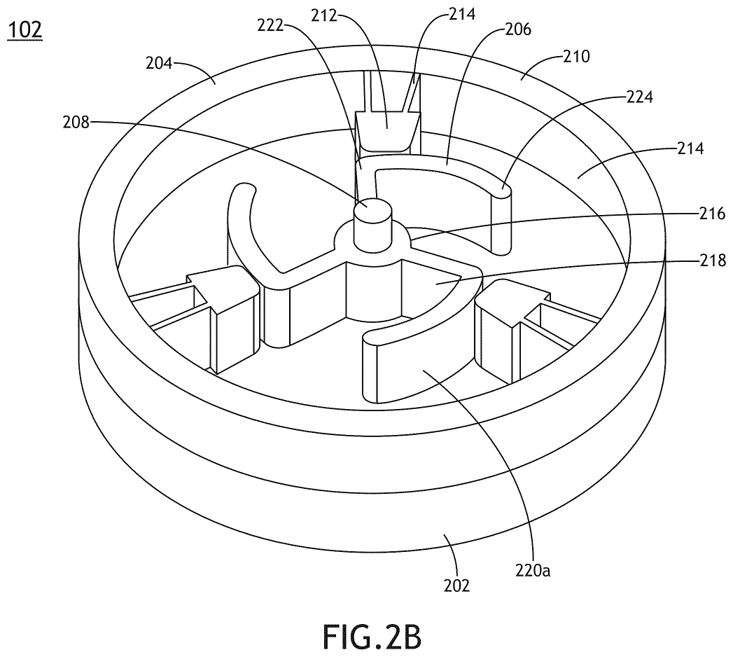

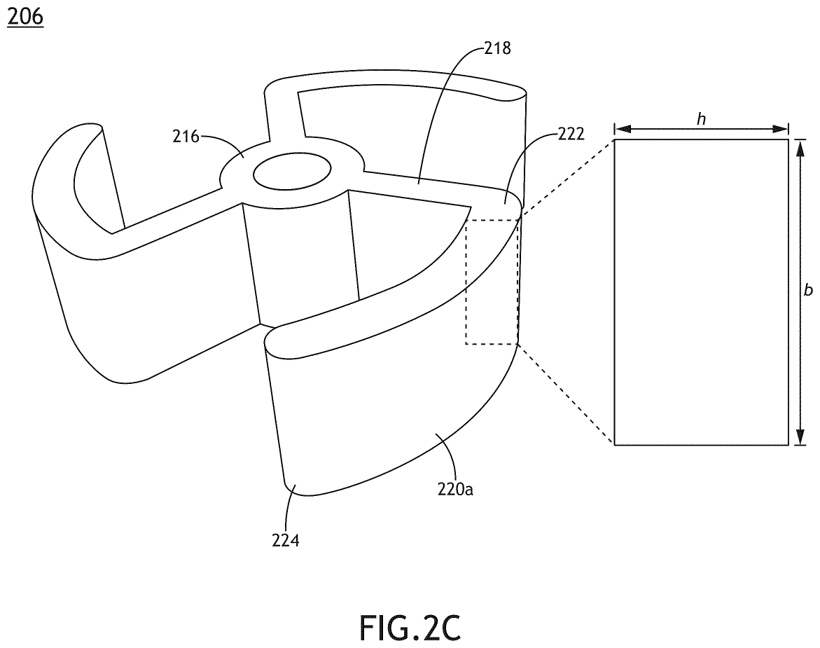

FIGS. 2A-2C illustrate the variable-stiffness mechanism 102, in accordance with one or more embodiments of the present disclosure. The variable-stiffness mechanism 102 may be configured as a cantilever-beam variable-stiffness mechanism. The variable-stiffness mechanism 102 may include a first unit 202, a second unit 204, a compliant member 206, and/or a fastener 208.

The first unit 202 and/or the second unit 204 may be a structure which supports one or more of the components of the variable-stiffness mechanism 102 depending upon the orientation of the variable-stiffness mechanism 102. For example, the first unit 202 may be a base which supports the second unit 204, the compliant member 206, and/or the fastener 208. By way of another example, the second unit 204 may be the base which supports the first unit 202, the compliant member 206, and/or the fastener 208. The first unit 202 and/or the second unit 204 may be an end effector of the actuator 104, where the other is the base. In this regard, one of the first unit 202 or the second unit 204 may provide the base and the other may provide the end effector.

The second unit 204 may be configured to rotate relative to the first unit 202. The second unit 204 may be coaxial with the first unit 202 and/or axially offset from the first unit 202. The first unit 202 may provide a plane for the second unit 204 to move about and may provide a location to fix the compliant member 206 at a center axis.

The first unit 202 and the second unit 204 may be coupled to one or more components of the system 100. For example, the first unit 202 may be coupled to one of the local ground 106 or the actuator 104, with the second unit 204 coupled to the other of the local ground 106 or the actuator 104.

The second unit 204 may include one or more portions. For example, the second unit 204 may include an outer-annular portion 210, contact portions 212, and/or outer-connecting portions 214.

A centered-hole defined by the outer-annular portion 210 may define the center axis of the second unit 204. The centered-hole defined by the outer-annular portion 210 may be any type of hole such as, but not limited to, a through-hole or a blind-hole. As depicted the centered-hole is a through-hole although this is not intended to be limiting.

The contact portions 212 may be disposed radially inwards of and axially aligned with the outer-annular portion 210. The second unit 204 may include at least three of the contact portions 212. For example, the second unit 204 may include three of the contact portions 212.

The contact portions 212 may be defined in a polar array about the center axis of the second unit 204. Centerlines of the contact portions 212 may be defined with a select spacing to adjacent centerlines of the contact portions 212. The spacing between adjacent centerlines of the contact portions 212 may be based on the number of the contact portions 212 where the contact portions 212 are defined in the polar array. For example, the spacing between adjacent centerlines of the contact portions 212 may be 120 degrees where the second unit 204 includes three of the contact portions 212 in the polar array.

The contact portions 212 may include a shape. For example, the contact portions 212 may include a rounded-trapezoid shape. The rounded-trapezoid shape may be beneficial to allow the compliant member 206 to slide on the contact portions 212 as the second unit 204 rotates relative to the compliant member 206, without the compliant member 206 getting caught on the contact portions 212. It is further contemplated that the contact portions 212 may include other shapes.

The outer-connecting portions 214 may be radially disposed between the outer-annular portion 210 and the contact portions 212. The outer-connecting portions 214 may connect respective of the contact portions 212 with the outer-annular portion 210. For example, the contact portions 212 and the outer-annular portion 210 may be connected by pairs of the outer-connecting portions 214. The second unit 204 may include any number of the outer-connecting portions 214 connecting respective of the contact portions 212 with the outer-annular portion 210. For example, the second unit 204 may include pairs of the outer-connecting portions 214 connecting respective of the contact portions 212 with the outer-annular portion 210. For instance, the second unit 204 may include pairs of the outer-connecting portions 214 connecting each of the three of the contact portions 212 with the outer-annular portion 210, for a total of six of the outer-connecting portions 214, although this is not intended to be limiting.

The outer-connecting portions 214 connecting respective of the contact portions 212 with the outer-annular portion 210 may be circumferentially separated from each other by a gap distance. The gap distance may be defined between the pairs of the outer-connecting portions 214. The gap distance may be any suitable shape. For example, the gap distance may include a trapezoidal-shape. The outer-connecting portions 214 may include a select thickness and/or elasticity. In embodiments, the elasticity of the outer-connecting portions 214 may provide compliance between the outer-annular portion 210 and the contact portions 212. For example, the contact portions 212 may flex relative to the outer-annular portion 210 via the outer-connecting portions 214.

Although the second unit 204 is described as including the outer-connecting portions 214, this is not intended as a limitation of the present disclosure. It is contemplated that the contact portions 212 may extend directly from the outer-annular portion 210. However, such arrangement may not provide compliance between the outer-annular portion 210 and the contact portions 212.

The compliant member 206 may be fixed to the first unit 202. For example, the compliant member 206 may be fixed to the first unit 202 via the fastener 208. The fastener 208 may include, but is not limited to, a pin. The fastener 208 may pin the compliant member 206 to the first unit 202. The fastener 208 may prevent rotation of the compliant member 206 relative to the first unit 202.

The compliant member 206 may be coaxial with the first unit 202 and/or axially offset from the first unit 202. The compliant member 206 may be coaxial with, axially aligned with, and/or disposed radially inwards of the second unit 204. For example, the second unit 204 and the compliant member 206 may each be axially offset from the first unit 202 by a same distance.

The compliant member 206 may include one or more portions. For example, the compliant member 206 may include an inner-annular portion 216, inner-connecting portions 218, and/or arc-segment portions 220.

The inner-annular portion 216 may define a center axis of the compliant member 206. The inner-annular portion 216 may receive the fastener 208. For example, the fastener 208 may fix the inner-annular portion 216 of the compliant member 206 to the first unit 202.

The inner-connecting portions 218 may extend radially outwards from the inner-annular portion 216. The inner-connecting portions 218 may extend radially inwards from the arc-segment portions 220. The inner-connecting portions 218 may be disposed radially outwards of the inner-annular portion 216. The inner-connecting portions 218 may be radially disposed between the inner-annular portion 216 and the arc-segment portions 220. The inner-connecting portions 218 may connect respective of the arc-segment portions 220 to the inner-annular portion 216.

The arc-segment portions 220 may be cantilever beams. The arc-segment portions 220 may cantilever circumferentially from the inner-connecting portions 218. The arc-segment portions 220 may include supported ends 222 and unsupported ends 224. The supported ends 222 and the unsupported ends 224 may be disposed at opposing ends of the arc-segment portions 220. The supported ends 222 may be circumferentially aligned with and supported by the inner-connecting portions 218. The arc-segment portions 220 may extend circumferentially from the inner-connecting portions 218. The unsupported ends 224 may be at the opposite circumferential length of the arc-segment portions 220 to the inner-connecting portions 218.

The compliant member 206 may include at least three of the inner-connecting portions 218 and at least three of the arc-segment portions 220. For example, the compliant member 206 may include three of inner-connecting portions 218 and three of the arc-segment portions 220. The variable-stiffness mechanism 102 may include a matching number of the contact portions 212, the inner-connecting portions 218, and the arc-segment portions 220. The inner-connecting portions 218 and the arc-segment portions 220 may be defined in the polar array about the center axis of the second unit 204.

The arc-segment portions 220 may be disposed radially between the contact portions 212 and the inner-connecting portions 218. The arc-segment portions 220 may be disposed radially outwards of the inner-connecting portions 218. The arc-segment portions 220 may be disposed radially inwards of the contact portions 212.

The second unit 204 may be constrained to the first unit 202 through coupling with the first unit 202 and/or the compliant member 206. The first unit 202 and/or the compliant member 206 may maintain the second unit 204 in a neutral position. The second unit 204 may be coaxial with the first unit 202 in the neutral position. The contact portions 212 may each be equidistance from the center axis in the neutral position. The second unit 204 may also be acted upon externally to translate the second unit 204 from the neutral position, where the translation is orthogonal to the center axis. The external force may radially translate the second unit 204 such that the second unit 204 is no longer coaxial with the first unit 202. Upon being acted upon externally, the arc-segment portions 220 may provide a spring force to move the second unit 204 back to the neutral position.

The second unit 204 may couple with the first unit 202. The second unit 204 may couple with the first unit 202 by abutting the first unit 202. For example, a bottom surface of the second unit 204 may abut a top surface of the first unit 202. The abutment may prevent axial translation of the second unit 204 towards the first unit 202. It is further contemplated that the first unit 202 and the second unit 204 may be coupled by a bearing (not depicted) disposed axially between the first unit 202 and the second unit 204. The bearing may be a plain bearing (e.g., a thrust bushing), a thrust bearing, or the like. The second unit 204 may or may not be constrained to prevent axial translation away from the first unit 202.

The second unit 204 may couple with the compliant member 206 by abutting the compliant member 206. For example, the contact portions 212 of the second unit 204 may abut the arc-segment portions 220 of the compliant member 206. The contact portions 212 may maintain abutment with the arc-segment portions 220 as the second unit 204 rotates relative to the first unit 202 and/or the compliant member 206. For example, the contact portions 212 may maintain the abutment with the arc-segment portions 220 along the length of the arc-segment portions 220 from the supported ends 222 to the unsupported ends 224.

The inner-connecting portions 218 may or may not be circumferentially aligned with the contact portions 212 when the contact portions 212 abut the arc-segment portions 220. For example, the inner-connecting portions 218 may be circumferentially aligned with the contact portions 212 when the contact portions 212 abuts the supported ends 222 of the arc-segment portions 220. By way of another example, the inner-connecting portions 218 may not be circumferentially aligned with the contact portions 212 when the contact portions 212 abuts the unsupported ends 224.

The arc-segment portions 220 may extend circumferentially from the inner-connecting portions 218 with a handedness. The arc-segment portions 220 may extend circumferentially from the inner-connecting portions 218 with a clockwise handedness or a counter-clockwise handedness from a perspective opposite to the first unit 202 (e.g., from above the compliant member 206 where the compliant member 206 is between the observer and the first unit 202). For example, the arc-segment portions 220 are depicted as extending circumferentially from the inner-connecting portions 218 with clockwise handedness from the perspective above the first unit 202, although this is not intended to be limiting. The arc-segment portions 220 may each include the same handedness.

The range of rotation of the second unit 204 relative to the compliant member 206 may be along the arc-segment portions 220 from where the contact portions 212 abut the supported ends 222 to where the contact portions 212 abut the unsupported ends 224.

The inner-connecting portions 218 and/or the arc-segment portions 220 may include a selected thickness and/or elasticity. The elasticity of the inner-connecting portions 218 and/or the arc-segment portions 220 may provide compliance between the arc-segment portions 220 and the contact portions 212. A stiffness of the variable-stiffness mechanism 102 may be based on the elasticity.

The stiffness of the variable-stiffness mechanism 102 may also be based on the circumferential position at which the contact portions 212 abut the arc-segment portions 220. The circumferential position may be defined between the unsupported ends 224 and the supported ends 222. For example, the variable-stiffness mechanism 102 may include a lowest stiffness when the contact portions 212 abuts the unsupported ends 224. By way of another example, the variable-stiffness mechanism 102 may include a highest stiffness when the contact portions 212 abut the supported ends 222.

The variable-stiffness mechanism 102 may define an effective beam length. The effective beam length may be the length along the arc-segment portions 220 between the inner-connecting portions 218 and the abutment between the contact portions 212 and the arc-segment portions 220. As the second unit 204 rotates relative to the compliant member 206 through the range of rotation, the effective beam length increases from a minimum when the contact portions 212 abut the supported ends 222 to a maximum when the contact portions 212 abut the unsupported ends 224. The change in the effective beam length may cause the change in the stiffness.

The arc-segment portions 220 may include any suitable shape. In embodiments, the arc-segment portions 220 may include spiral-shaped arc-segment portions 220a. The radius from the spiral-shaped arc-segment portions 220a may increase along the length of the spiral-shaped arc-segment portions 220a with a shortest radius at the supported ends 222 and a longest radius at the unsupported ends 224. The supported ends 222 may be disposed radially inwards of the unsupported ends 224. The spiral-shaped arc-segment portions 220a may include any two-dimensional spiral shape, such as, but not limited to, an Archimedean Spiral, a hyperbolic spiral, or the like. For example, the arc-segment portions 220 are depicted as the Archimedean Spirals, although this is not intended to be limiting. The spiral-shaped arc-segment portions 220a may arc with a consistently increasing radial curvature along the Archimedean Spirals.

The change in radius of the two-dimensional spiral shape of the spiral-shaped arc-segment portions 220a may control the stiffness. The two-dimensional spiral shape of the spiral-shaped arc-segment portions 220a may be used to change the effective beam length of the arc-segment portions 220 while also applying a preload on the contact portions 212. The preload may be a spring force acting radially outwards. With the two-dimensional spiral shape, as the radius increases and the spiral-shaped arc-segment portions 220a are rotated relative to the contact portions 212, the preload and the effective beam length of the spiral-shaped arc-segment portions 220a may each increase. The preload and the effective beam length may each contribute to the stiffness. For example, increasing the preload may serve to increase the stiffness. The contribution to increasing the stiffness from increasing the preload may be less significant than decreasing the stiffness from the increase in the effective beam length. Thus, the spiral-shaped arc-segment portions 220a with the two-dimensional spiral shape may utilize two principles to control the stiffness: changing the preload and the effective beam length. The preload may be beneficial to prevent losing too much stiffness towards the unsupported ends 224.

To characterize the stiffness of the variable-stiffness mechanism 102, the Pseudo Rigid Body Model is used. The arc-segment portions 220 may be identified as an initially curved cantilever beam. The ratio (K_{O}) between the effective beam length (I) and the radius of initial curvature (Rᵢ) of the beam is a nondimensionalized parameter and may be expressed as:

$${κ}_{O} = \frac{l}{{R}_{i}}$$

The ratio (K_{O}) may vary as the radius of initial curvature (Rᵢ) increases further along the spiral-shaped arc-segment portions 220a from the supported ends 222 to the unsupported ends 224. For a given value of the ratio (K_{O}), tabulated data are used to find a functional parameter (φ, used in conjunction with the length of the curvature, and the stiffness coefficient (K_{Θ}). A torsional stiffness (K) may be found from the area moment of inertia (I), modulus of elasticity (E), and effective beam length (I) of the beam, and may be expressed as:

$$K = ρ {K}_{Θ} \frac{EI}{l}$$

Furthermore, the area moment of inertia (I) may be characterized based on the height (b) of the beam and the width (h) of the beam, and may be expressed as:

$$I = \frac{{bh}^{3}}{12}$$

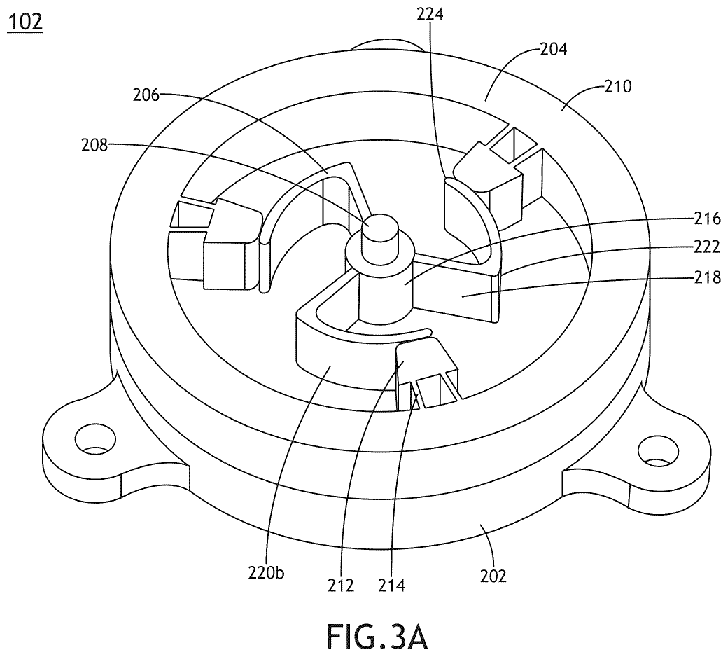

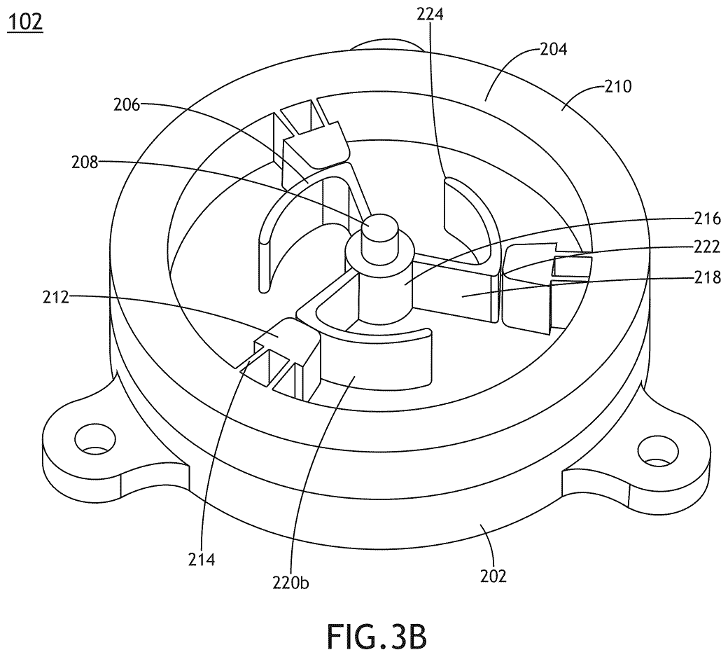

FIGS. 3A-3B illustrate the variable-stiffness mechanism 102, in accordance with one or more embodiments of the present disclosure. Although the arc-segment portions 220 are described as spiral-shaped arc-segment portions 220a, this is not intended as a limitation of the present disclosure. In embodiments, the arc-segment portions 220 may be circular-shaped arc-segment portions 220b. The radius of the circular-shaped arc-segment portions 220b may be uniform along the length between the supported ends 222 and the unsupported ends 224.

The variable-stiffness mechanism 102 with the circular-shaped arc-segment portions 220b may include a lowest stiffness where the contact portions 212 abuts the unsupported ends 224 and a highest stiffness where the contact portions 212 abut the supported ends 222. The circular-shaped arc-segment portions 220b may provide the variable stiffness due to the change in the effective beam length. The circular-shaped arc-segment portions 220b may achieve the change in stiffness via the effective beam length without applying the preload on the contact portions 212. With this configuration, the circular-shaped arc-segment portions 220b may not provide spring force on the second unit 204 until the external loads is applied to displace the second unit 204 from the neutral position. The supported ends 222 may be radially aligned with the unsupported ends 224 for the circular-shaped arc-segment portions 220b.

The circular-shaped arc-segment portions 220b may also be characterized as an initially curved cantilever beam. The ratio (K_{O}) may be found from the radius of initial curvature (Rᵢ) and the effective beam length (I). In this example, the radius of initial curvature (Rᵢ) of the circular-shaped arc-segment portions 220b does not change along the length of the circular-shaped arc-segment portions 220b.

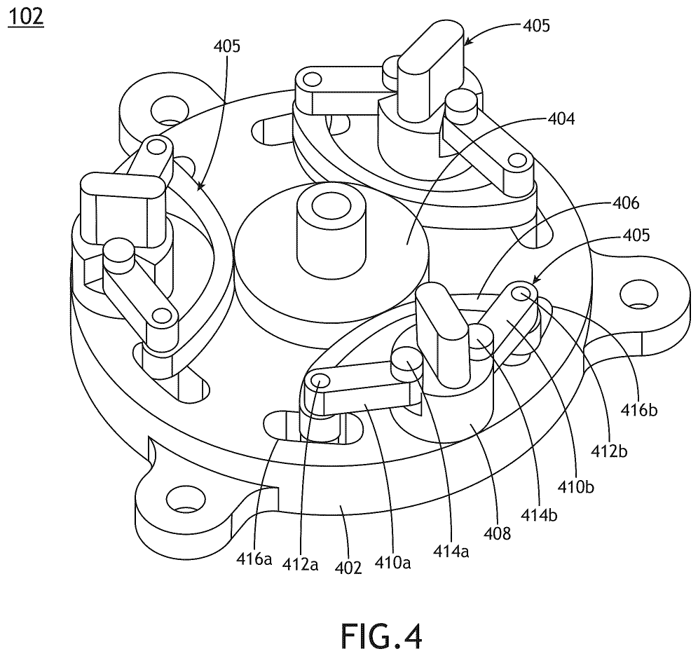

FIG. 4 illustrates a variable-stiffness mechanism 400, in accordance with one or more embodiments of the present disclosure. The discussion of the variable-stiffness mechanism 102 is incorporated herein by reference as to the variable-stiffness mechanism 400. The variable-stiffness mechanism 400 may be a crank-slider variable-stiffness mechanism. The variable-stiffness mechanism 400 may include a first unit 402, a second unit 404, crank-slider subassemblies 405, compliant members 406, input cranks 408, connecting rods 410, rod-to-member revolute joints 412, and/or crank-to-rod revolute joints 414.

The discussion of the first unit 202 is incorporated herein by reference as to the first unit 402. The discussion of the second unit 204 is incorporated herein by reference as to the second unit 404. The first unit 402 and/or the second unit 404 may be a structure which supports one or more of the components of the variable-stiffness mechanism 102 depending upon the orientation of the variable-stiffness mechanism 102. The second unit 404 may be configured to rotate relative to the first unit 402. The second unit 404 may be coaxial with the first unit 402 and/or axially offset from the first unit 402. The first unit 402 may provide a plane for the second unit 404 to move about. The first unit 402 and/or the second unit 404 may be an end effector of the actuator 104, where the other is the base. In this regard, one of the first unit 402 or the second unit 404 may provide the base and the other may provide the end effector. The first unit 402 and the second unit 404 may be coupled to one or more components of the system 100. For example, the first unit 402 may be coupled to one of the local ground 106 or the actuator 104, with the second unit 404 coupled to the other of the local ground 106 or the actuator 104.

The first unit 402 may support the second unit 404, crank-slider subassemblies 405, compliant members 406, input cranks 408, connecting rods 410, rod-to-member revolute joints 412, and/or crank-to-rod revolute joints 414.

The second unit 404 may be disposed radially inwards of and axially aligned with the crank-slider subassemblies 405, the compliant members 406, the input cranks 408, the connecting rods 410, the rod-to-member revolute joints 412, and/or the crank-to-rod revolute joints 414. The compliant members 406 may be disposed radially between the second unit 404 and the input cranks 408.

The crank-slider subassemblies 405 may include the compliant members 406, the input cranks 408, the connecting rods 410, the rod-to-member revolute joints 412, and/or the crank-to-rod revolute joints 414. Each of the crank-slider subassemblies 405 may include one of the compliant members 406, one of the input cranks 408, a pair of the connecting rods 410, a pair of the rod-to-member revolute joints 412, and/or a pair of the crank-to-rod revolute joints 414. For instance, the pair of the connecting rods 410 may include first connecting rods 410a and second connecting rods 410b, the pair of the rod-to-member revolute joints 412 may include first rod-to-member revolute joints 412a and second rod-to-member revolute joints 412b, and/or the pair of the crank-to-rod revolute joints 414 may include first crank-to-rod revolute joints 414a and second crank-to-rod revolute joints 414b.

The variable-stiffness mechanism 400 may include at least three of the crank-slider subassemblies 405. For example, the variable-stiffness mechanism 400 may include three of the crank-slider subassemblies 405. In this example, the variable-stiffness mechanism 400 may include a total of three of the compliant members 406, three of the input cranks 408, three pairs of the connecting rods 410, three pairs of the rod-to-member revolute joints 412, and three pairs of the crank-to-rod revolute joints 414.

The crank-slider subassemblies 405 may be defined in a polar array about the center axis of the second unit 404. Centerlines of the crank-slider subassemblies 405 may be defined by the input cranks 408. The input cranks 408 may be defined with a select spacing to adjacent of the input cranks 408. The spacing between adjacent of the input cranks 408 may be based on the number of the crank-slider subassemblies 405 defined in the polar array. For example, the spacing between adjacent of the input cranks 408 may be 120 degrees where the variable-stiffness mechanism 400 includes three of the crank-slider subassemblies 405 in the polar array.

The crank-slider subassemblies 405, the compliant members 406, the input cranks 408, the connecting rods 410, the rod-to-member revolute joints 412, and/or the crank-to-rod revolute joints 414 may be axially offset from the first unit 402 and/or axially aligned with the second unit 404. A portion of the rod-to-member revolute joints 412 may also be axially aligned with the first unit 402 and disposed in the slotted arcs 416.

The compliant members 406 may be coupled to the connecting rods 410 by the rod-to-member revolute joints 412. The compliant members 406 may be configured to revolve relative to the connecting rods 410 about the rod-to-member revolute joints 412.

Opposing ends of the compliant members 406 may be coupled to the pairs of the connecting rods 410 by the pairs of the rod-to-member revolute joints 412. For example, a first end of the compliant members 406 may be coupled to the first connecting rods 410a by the first crank-to-rod revolute joints 414a, while a second end of the compliant members 406 may be coupled to the second connecting rods 410b by the second crank-to-rod revolute joints 414b.

The connecting rods 410 may also be referred to as crank arms. The connecting rods 410 may be coupled to the input cranks 408 by the crank-to-rod revolute joints 414. The connecting rods 410 may be configured to revolve relative to the input cranks 408 about the crank-to-rod revolute joints 414. For example, the first connecting rods 410a may be coupled to the input cranks 408 by the first crank-to-rod revolute joints 414a, while the second connecting rods 410b may be coupled to the input cranks 408 by the second crank-to-rod revolute joints 414b. The first connecting rods 410a and the second connecting rods 410b may be coupled to opposing sides of the input cranks 408.

Opposing ends of the connecting rods 410 may be coupled to the compliant members 406 by the rod-to-member revolute joints 412 and to the input cranks 408 by the crank-to-rod revolute joints 414. For example, a first end of the connecting rods 410 may be coupled to the compliant members 406 by the rod-to-member revolute joints 412 and a second end of the connecting rods 410 may be coupled to the input cranks 408 by the crank-to-rod revolute joints 414.

The rod-to-member revolute joints 412 and/or the crank-to-rod revolute joints 414 may include axes of rotation. The axes of rotation of the rod-to-member revolute joints 412 and/or the crank-to-rod revolute joints 414 may be parallel. The axes of rotation may also be parallel with and radially offset from the center axis of the variable-stiffness mechanism 400.

The first unit 402 may define slotted arcs 416. The slotted arcs 416 may be revolved at a common radius about the center axis of the first unit 402. The slotted arcs 416 may be circular cams within which respective of the rod-to-member revolute joints 412 are configured to follow. The compliant members 406, the rod-to-member revolute joints 412, and/or the crank-to-rod revolute joints 414 may be configured translate radially and/or circumferentially as the rod-to-member revolute joints 412 follow within the slotted arcs 416. For example, a circumferential center of the compliant members 406 to which the second unit 404 abuts may flex radially inwards and outwards as the crank-to-rod revolute joints 414 (e.g., in combination with the circumferential ends of the compliant members 406) translate circumferentially within the slotted arcs 416. The first unit 402 may define a pair of the slotted arcs 416 for each of the crank-slider subassemblies 405 and/or one of the slotted arcs 416 for each of the rod-to-member revolute joints 412. For example, the first unit 402 may define a first slotted-arc 416a within which the first rod-to-member revolute joints 412a may follow, and may define a second slotted-arc 416b within which the second rod-to-member revolute joints 412b may follow.

The input cranks 408 may be coupled to the first unit 402 by a revolute joint (not depicted). The input cranks 408 may be configured to rotate relative to the first unit 402. The input cranks 408 may not translate relative to the first unit 402. The input cranks 408 may be disposed circumferentially between the pair of the slotted arcs 416 for each of the crank-slider subassemblies 405.

The second unit 404 may be constrained to the first unit 402 through coupling with the first unit 402 and/or the compliant members 406. The first unit 402 and/or the compliant members 406 may maintain the second unit 404 in a neutral position. The second unit 404 may be centered on the first unit 402 in the neutral position. The second unit 404 may also be acted upon externally to translate the second unit 404 from the neutral position, where the translation is orthogonal to the center axis. Upon being acted upon externally, the compliant members 406 may provide a spring force to move the second unit 404 back to the neutral position.

The second unit 404 may couple with the first unit 402. The second unit 404 may couple with the first unit 402 by abutting the first unit 402. For example, a bottom surface of the second unit 404 may abut a top surface of the first unit 402. The abutment may prevent axial translation of the second unit 404 towards the first unit 402. It is further contemplated that the first unit 402 and the second unit 404 may be coupled by a bearing (not depicted) disposed axially between the first unit 402 and the second unit 404. The bearing may be a plain bearing (e.g., a thrust bushing), a thrust bearing, or the like.

The second unit 404 may couple with the compliant members 406 by abutting the compliant members 406. For example, the compliant members 406 may abut an outer diameter of the second unit 404. The second unit 404 may maintain the abutment with the compliant members 406 as the rod-to-member revolute joints 412 follow within the slotted arcs 416.

The compliant members 406 may include a selected thickness and/or elasticity. In embodiments, the elasticity of the compliant members 406 may provide compliance between the second unit 404 and the compliant members 406. A stiffness of the variable-stiffness mechanism 400 may be based on the elasticity.

The stiffness of the variable-stiffness mechanism 400 may also be varied based on the flexure of the compliant members 406. The compliant members 406 may be flexed radially inwards to increase the stiffness and radially outwards to decrease the stiffness. The compliant members 406 may apply a preload to the second unit 404. With the compliant members 406 applying the preload to the second unit 404, a constant positive stiffness acts on the second unit 404, giving the second unit 404 an immediate response to any external forces acting upon the second unit 404.

The rod-to-member revolute joints 412 may cause flexing of the compliant members 406 radially inwards and radially outwards. Flexing the compliant members 406 radially inwards and radially outwards may respectively increase and decrease the stiffness of the variable-stiffness mechanism 400. For example, motion of the first rod-to-member revolute joints 412a and the second rod-to-member revolute joints 412b circumferentially away from each other may cause the compliant members 406 to flex radially outwards and away from the second unit 404, thereby decreasing the stiffness of the variable-stiffness mechanism 400. By way of another example, motion of the first rod-to-member revolute joints 412a and the second rod-to-member revolute joints 412b circumferentially towards each other may cause the compliant members 406 to flex radially inwards and towards the second unit 404, thereby increasing the stiffness of the variable-stiffness mechanism 400.

The variable-stiffness mechanism 400 may change the stiffness by rotating the input cranks 408 relative to the first unit 402. Rotating the input cranks 408 relative to the first unit 402 may cause the pairs of the connecting rods 410 to translate circumferentially apart. Translating the pairs of the connecting rods 410 circumferentially apart may translate the pairs of the rod-to-member revolute joints 412 circumferentially apart within the slotted arcs 416, thus increasing the length between the pairs of the rod-to-member revolute joints 412. Increasing the length between the pairs of the rod-to-member revolute joints 412 may flex the compliant members 406 radially outwards away from the second unit 404. Flexing the compliant members 406 radially outwards may decrease the stiffness. Similarly, the input cranks 408 may be returned to a neutral position causing the pairs of the connecting rods 410 to translate circumferentially together. Translating the pairs of the connecting rods 410 circumferentially together may translate the pairs of the rod-to-member revolute joints 412 circumferentially together within the slotted arcs 416, thus decreasing the length between the pairs of the rod-to-member revolute joints 412. Decreasing the length between the pairs of the rod-to-member revolute joints 412 may flex the compliant members 406 radially inwards towards from the second unit 404. Flexing the compliant members 406 radially inwards may increase the stiffness. This follows under the principle of changing the properties and preload of the compliant members 406. The variable-stiffness mechanism 400 may include a lowest stiffness when the pairs of the rod-to-member revolute joints 412 are furthest apart within the slotted arcs 416 and may include a highest stiffness when closest together within the within the slotted arcs 416.

The flexure of the compliant members 406 may also provide a preload on the outer diameter of the second unit 404.

With a pseudo-rigid-body model (PRBM), the compliant members 406 may be defined as an initially curved pinned-pinned segment. The torsional stiffness (K) may be found from the functional parameter (ρ), the stiffness coefficient (K_{Θ}), the area moment of inertia (I), modulus of elasticity (E), and effective beam length (I) of the beam, and may be expressed as:

$$K = 2 ρ {K}_{Θ} \frac{EI}{l}$$

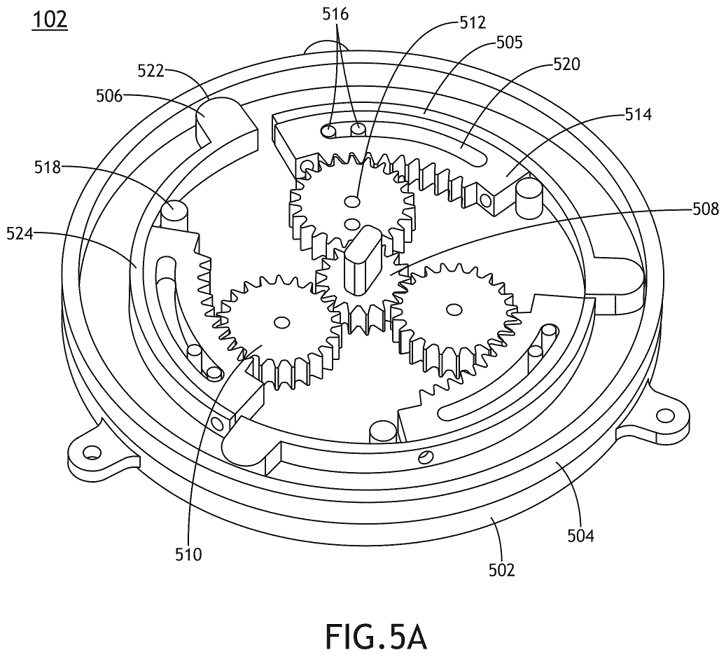

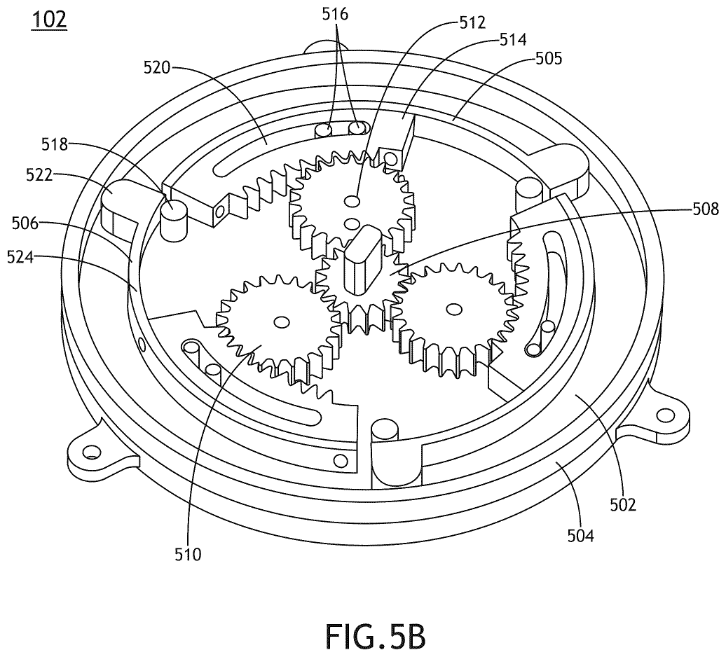

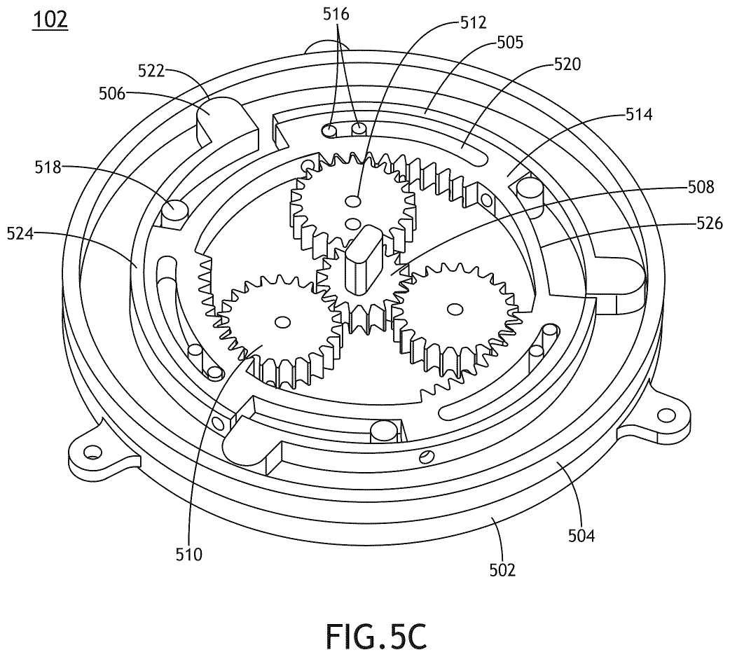

FIGS. 5A-5C illustrate a variable-stiffness mechanism 500, in accordance with one or more embodiments of the present disclosure. The discussion of the variable-stiffness mechanism 102 and the variable-stiffness mechanism 400 is incorporated herein by reference as to the variable-stiffness mechanism 500. The variable-stiffness mechanism 500 may be a gear-slider variable-stiffness mechanism. The variable-stiffness mechanism 500 may include a first unit 502, a second unit 504, a planetary gearset 505, compliant members 506, a sun gear 508, planet gears 510, unit-to-planet revolute joints 512, ring-gear segments 514, ring guides 516, and/or pivot pins 518.

The discussion of the first unit 202 and the first unit 402 are incorporated herein by reference as to the first unit 502. The discussion of the second unit 204 and the second unit 404 are incorporated herein by reference as to the second unit 504. The first unit 502 and/or the second unit 504 may be a structure which supports one or more of the components of the variable-stiffness mechanism 102 depending upon the orientation of the variable-stiffness mechanism 102. The second unit 504 may be configured to rotate relative to the first unit 502. The second unit 504 may be coaxial with the first unit 502 and/or axially offset from the first unit 502. The first unit 502 may provide a plane for the second unit 504 to move about. The first unit 502 and/or the second unit 504 may be an end effector of the actuator 104, where the other is the base. In this regard, one of the first unit 502 or the second unit 504 may provide the base and the other may provide the end effector. The first unit 502 and the second unit 504 may be coupled to one or more components of the system 100. For example, the first unit 502 may be coupled to one of the local ground 106 or the actuator 104, with the second unit 504 coupled to the other of the local ground 106 or the actuator 104.

The second unit 504 may be annular.

The planetary gearset 505 may also be referred to as an epicyclic gearset. The planetary gearset 505 may include the compliant members 506, the sun gear 508, the planet gears 510, the unit-to-planet revolute joints 512, the ring-gear segments 514, the ring guides 516, and/or the pivot pins 518.

The planetary gearset 505, the compliant members 506, the sun gear 508, planet gears 510, the unit-to-planet revolute joints 512, the ring-gear segments 514, the ring guides 516, and/or the pivot pins 518 may be axially aligned. The planetary gearset 505 may be disposed radially inwards of and axially aligned with the second unit 504.

The sun gear 508 may also be referred to as a central spur gear. The sun gear 508 may be an external gear. In this regard, the sun gear 508 may include teeth around an outer diameter of the sun gear 508. The sun gear 508 may include a central axis which may be coaxial with the central axes of the variable-stiffness mechanism 500 and/or the planetary gearset 505. The sun gear 508 may be configured to rotate relative to the first unit 502 about the central axis.

The planet gears 510 may also be referred to as idler spur gears. The planet gears 510 may be external gears. The planetary gearset 505 may include at least three of the planet gears 510. For example, the planetary gearset 505 may include three of the planet gears 510. The planet gears 510 may be disposed radially outwards of the sun gear 508.

The first unit 502 may hold the planet gears 510. For example, the planet gears 510 may be coupled to the first unit 502 by unit-to-planet revolute joints 512. The first unit 502 may act as a carrier for the planet gears 510. The planet gears 510 may be configured to rotate relative to the center axis of the first unit 502 and may be prevented from other relative motion to the first unit 502 by the unit-to-planet revolute joints 512.

The sun gear 508 may engage with the planet gears 510. For example, teeth of the sun gear 508 may mesh with teeth of the planet gears 510 thereby engaging the sun gear 508 with the planet gears 510. The planet gears 510 may include central axes which may be parallel to and offset from the central axis of the planetary gearset 505, the first unit 502, and/or the sun gear 508. The central axes may be the unit-to-planet revolute joints 512. Rotation of the sun gear 508 may cause the rotation of the planet gears 510 about the central axes of the planet gears 510. The planet gears 510 may also revolve around the sun gear 508 from a frame of reference of the ring-gear segments 514. The planet gears 510 may revolve around the sun gear 508 in a circle which is coaxial to the central axis of the sun gear 508. The revolution of the sun gear 508 may cause both the rotation of the planet gears 510 about the central axes of the planet gears 510 and the revolution of the planet gears 510 around the sun gear 508.

The planet gears 510 may provide a gear multiplication to the sun gear 508. The sun gear 508 and the planet gears 510 may include a select diameter and number of teeth to provide the gear multiplication. The diameter of the planet gears 510 may be smaller than the diameter of the sun gear 508 to provide the gear multiplication.

The ring-gear segments 514 may be internal gears. In this regard, the ring-gear segments 514 may include teeth along an inner diameter of the ring-gear segments 514. The planetary gearset 505 may include at least three of the ring-gear segments 514. For example, the planetary gearset 505 may include three of the ring-gear segments 514. The ring-gear segments 514 may be disposed radially outwards of the planet gears 510.

The planet gears 510 may engage with respective of the ring-gear segments 514. For example, teeth of the planet gears 510 may mesh with teeth of the ring-gear segments 514 thereby engaging the planet gears 510 with the ring-gear segments 514. Rotation of the planet gears 510 about the central axes of the planet gears 510 may cause the ring-gear segments 514 to revolve about the sun gear 508 from a frame of reference of the first unit 502 and/or the planet gears 510.

The ring guides 516 and/or the pivot pins 518 may be fixed to the first unit 502. The ring guides 516 and/or the pivot pins 518 may axially extend from the first unit 502. The ring-gear segments 514, the ring guides 516, and/or the pivot pins 518 may be radially aligned. The ring guides 516 may include a pair of pins (as depicted) or an arc-shaped guide (not depicted).

The ring-gear segments 514 may define slotted arcs 520. The slotted arcs 520 may be revolved at a common radius about the center axis of the variable-stiffness mechanism 500. The slotted arcs 520 may be circular cams within which respective of the ring guides 516 are configured to follow. The ring-gear segments 514 may be configured to revolve about the sun gear 508 as the ring guides 516 follow within the slotted arcs 520. The ring-gear segments 514 may revolve about the sun gear 508 for an arc length. The arc length to which the ring-gear segments 514 may revolve may be based on the arc lengths of the slotted arcs 520 minus the length of the ring guides 516.

The compliant members 506 may be disposed radially between the ring-gear segments 514 and the second unit 504. The compliant members 506 may be coupled to and revolve with respective of the ring-gear segments 514 about the planet gears 510. The compliant members 506 may be coupled to the ring-gear segments 514 by a pair of fasteners disposed at opposing ends of the slotted arcs 520. The compliant members 506 and the ring-gear segments 514 may each revolve in tandem.

The compliant members 506 may include contact portions 522 and/or arc-segment portions 524.

The contact portions 522 may include a shape. For example, the contact portions 522 may include a rounded-rectangle shape. The arc-segment portions 524 may circumferentially extend from the contact portions 522. The contact portions 522 may extend radially outwards from the arc-segment portions 524. The arc-segment portions 524 may be coupled to and supported by the ring-gear segments 514. The contact portions 522 may be disposed at an end of the arc-segment portions 524 not coupled to the ring-gear segments 514.

The arc-segment portions 524 may abut and pivot about the pivot pins 518. For example, an inner diameter of the arc-segment portions 524 may abut and pivot about the pivot pins 518. The revolution of the compliant members 506 about the planet gears 510 may change a position of the pivot pins 518 along the length of the compliant members 506.

The arc-segment portions 524 may include a selected thickness and/or elasticity. In embodiments, the elasticity of the arc-segment portions 524 may provide compliance between the arc-segment portions 524 and the second unit 504. A stiffness of the variable-stiffness mechanism 500 may be based on the elasticity.

The arc-segment portions 524 may be cantilever beams. The arc-segment portions 524 may cantilever from the ring-gear segments 514. The stiffness of the variable-stiffness mechanism 500 may also be based on the circumferential position of the pivot pins 518 abut along the length of the arc-segment portions 524. For example, the variable-stiffness mechanism 500 may include a lowest stiffness when the pivot pins 518 is disposed adjacent to the ring-gear segments 514. By way of another example, the variable-stiffness mechanism 500 may include a highest stiffness when the pivot pins 518 is circumferentially aligned with the contact portions 522. The variable-stiffness mechanism 500 thus operates by altering the effective beam length.

The variable-stiffness mechanism 500 may define an effective beam length. The effective beam length may be the length along the arc-segment portions 524 from the pivot pins 518 to the contact portions 522. As the ring-gear segments 514 and the second unit 504 revolves relative to the first unit 502 through the range of rotation, the effective beam length increases from a minimum when the pivot pins 518 are circumferentially aligned with the contact portions 522 to a maximum when the pivot pins 518 are disposed adjacent to the ring-gear segments 514. The change in the effective beam length may cause the change in the stiffness.

The second unit 504 may be constrained to the first unit 502 through coupling with the first unit 502 and/or the compliant members 506. The first unit 502 and/or the compliant members 506 may maintain the second unit 504 in a neutral position. The second unit 504 may be centered on the first unit 502 in the neutral position. The second unit 504 may also be acted upon externally to translate the second unit 504 from the neutral position, where the translation is orthogonal to the center axis. Upon being acted upon externally, the arc-segment portions 524 provide a spring force to move the second unit 504 back to the neutral position.

The second unit 504 may couple with the compliant members 506 by abutting the compliant members 506. For example, an inner diameter of the second unit 504 may abut the contact portions 522 of the compliant member 206. The second unit 504 may maintain abutment with the contact portions 522 as the compliant members 506 rotates relative to the first unit 502 and/or the second unit 504.

The sun gear 508 may be a drive gear for the planetary gearset 505. The sun gear 508 may be rotated. The rotation of the sun gear 508 may rotate the planet gears 510. The rotation of the planet gears 510 may cause the ring-gear segments 514 and the compliant members 506 to revolve about the sun gear 508. Each of the ring-gear segments 514 and the compliant members 506 may revolve in tandem through the rotation of the sun gear 508 and the planet gears 510. Thus, the sun gear 508 may be used to change position of the compliant members 506 relative to the pivot pins 518 and thereby change the stiffness of the variable-stiffness mechanism 500.

The variable-stiffness mechanism 500 may be modelled as an initially curved cantilever beam with an intermediate simple support. Due to this unusual (indeterminate) structure, there is no formal pseudo-rigid-body model available to analytically solve for the stiffness of the variable-stiffness mechanism 500. Thus, an approximate analytical model for the variable-stiffness mechanism 500 was derived through superposition and assuming a beam with no curvature and small deflections. The resulting tip deflection (0) may be used in conjunction with Hooke's law to find the equivalent stiffness, and may be expressed as:

$$δ = \frac{{Fa}^{2} ( l + a )}{3 EI}$$

Here (a) is the effective beam length between the simple (pinned) support and the force (F) acting at the beam tip, and (I) is the distance between the fixed end and the simple support.

In embodiments, the ring-gear segments 514 may be disconnected. The ring-gear segments 514 may each be separate components. The ring-gear segments 514 may be separated from and disconnected from adjacent of the ring-gear segments 514 by a circumferential gap in which the pivot pins 518 are disposed.

In embodiments, the ring-gear segments 514 may be connected by connecting segments 526. The connecting segments 526 may be radially aligned with the ring-gear segments 514. The connecting segments 526 may circumferentially extend between and couple adjacent of the ring-gear segments 514. The ring-gear segments 514 and the connecting segments 526 may form a ring gear. The connecting segments 526 may be disposed radially inwards of and circumferentially aligned with respective of the pivot pins 518. The compliant members 506 may be elastically deformed up to the connecting segments 526. The connecting segments 526 may or may not abut the pivot pins 518. For example, the connecting segments 526 may be separated from the pivot pins 518 by a gap. The connecting segments 526 may or may not mesh with the planet gears 510. For example, the connecting segments 526 may be annular segments with an inner radius which does not mesh with the planet gears 510.

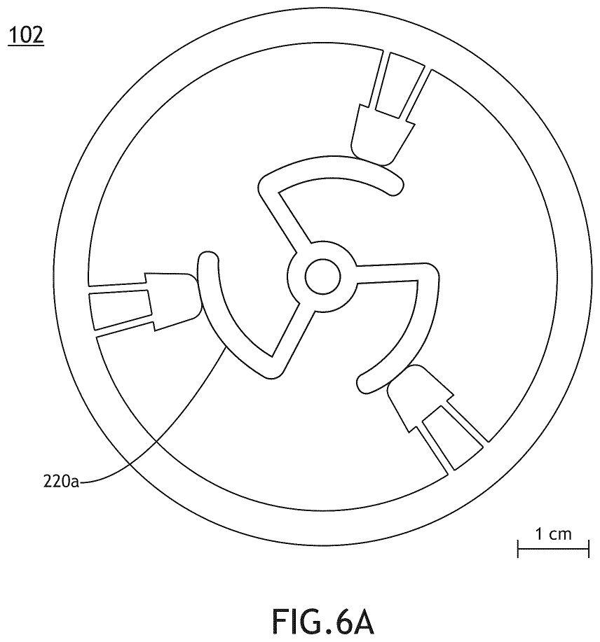

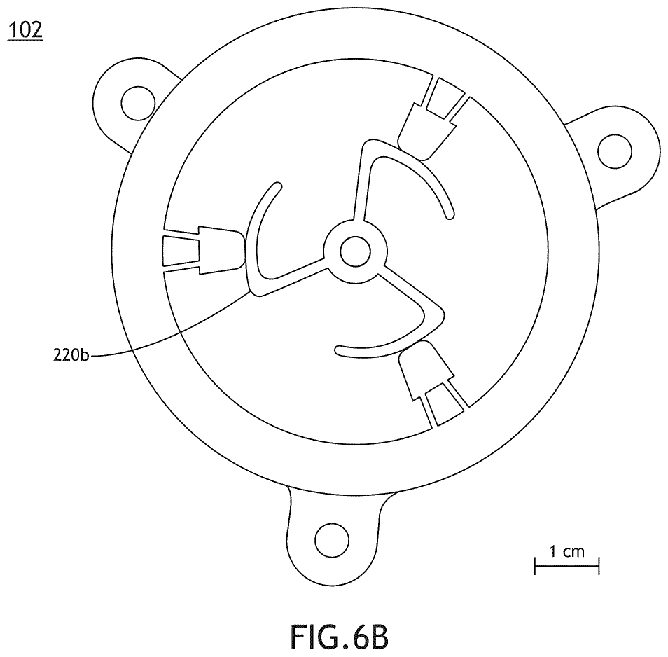

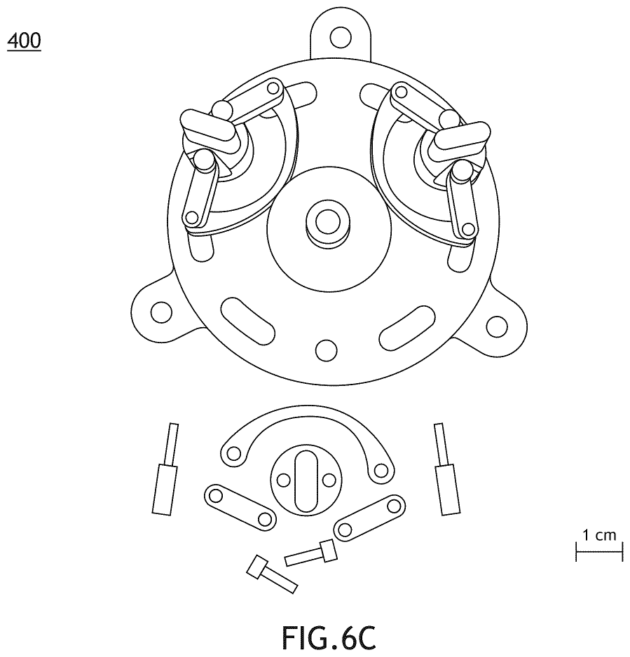

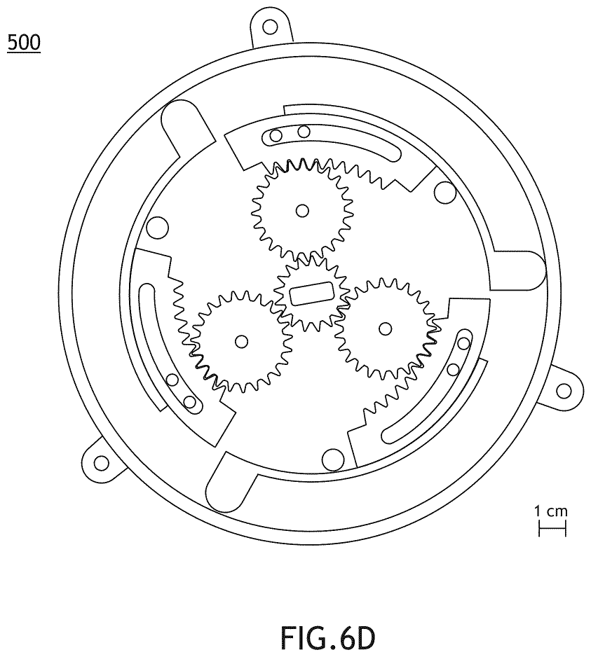

FIGS. 6A-6D illustrates the variable-stiffness mechanisms, in accordance with one or more embodiments of the present disclosure. The variable-stiffness mechanism 102, the variable-stiffness mechanism 400, and the variable-stiffness mechanism 500 were fabricated by additive manufacturing. The materials used were PLA Matte for rigid components and PAHT-CF (e.g., a carbon fiber reinforced nylon) for the compliant members.

The variable-stiffness mechanism 102 with the spiral-shaped arc-segment portions 220a, the variable-stiffness mechanism 102 with the circular-shaped arc-segment portions 220b, and the variable-stiffness mechanism 400 were made to be 75 mm (2.95 inch) in diameter. The variable-stiffness mechanism 500 was made slightly larger to facilitate the printing and detailing of the gears. Between printing mechanisms, it was noticed that the thickness of the spiral-shaped arc-segment portions 220a was thicker (stiffer) than expected. In response to this, the thickness of the circular-shaped arc-segment portions 220b was halved; this is also reflected in the results below.

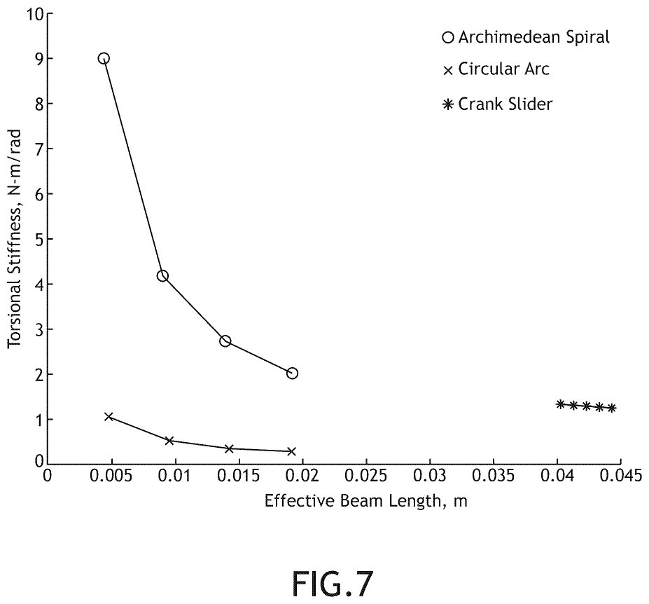

FIG. 7 illustrates a graph 700, in accordance with one or more embodiments of the present disclosure. The graph 700 depicts torsional stiffness in newton meters per radian as a function of an effective beam length in meters. The graph 700 includes the torsional stiffness of the variable-stiffness mechanism 102 with the spiral-shaped arc-segment portions 220a configured as the Archimedean spiral, the variable-stiffness mechanism 102 with the circular-shaped arc-segment portions 220b, and the variable-stiffness mechanism 400 configured as the crank-slider.

The range of torsional stiffness for the variable-stiffness mechanisms 102 with the spiral-shaped arc-segment portions 220a and the circular-shaped arc-segment portions 220b can be smoothly compared as they have similar arc lengths. In this example, the torsional stiffness of the variable-stiffness mechanism 102 with the spiral-shaped arc-segment portions 220a varies between about 2 and 9 newton meters per radian over the effective beam length while the torsional stiffness of the variable-stiffness mechanism 102 with the circular-shaped arc-segment portions 220b varies between about 0 and 1 newton meters per radian over the effective beam length.

The range of torsional stiffness for the variable-stiffness mechanism 400 configured as the crank-slider is shifted right due to the difference in total length. In this example, the torsional stiffness of the variable-stiffness mechanism 400 is about 1 newton meters per radian over the effective beam length. Moreover, due to the nature of how the variable-stiffness mechanism 400 achieves the torsional stiffness, only small displacement can be performed without risking the integrity of the compliant members 406 as currently built, further limiting the range of values of the torsional stiffness. The point of contact between the second unit 404 and the compliant members 406 remains the same through the displacement of the compliant members 406.

The variable-stiffness mechanism 500 is not analyzed in the graph 700 due to not including a pseudo-rigid-body model.

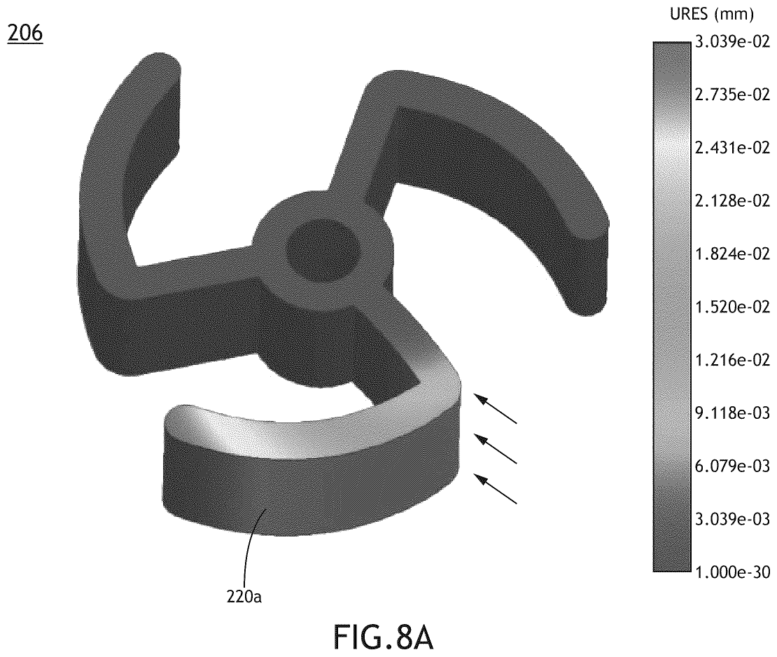

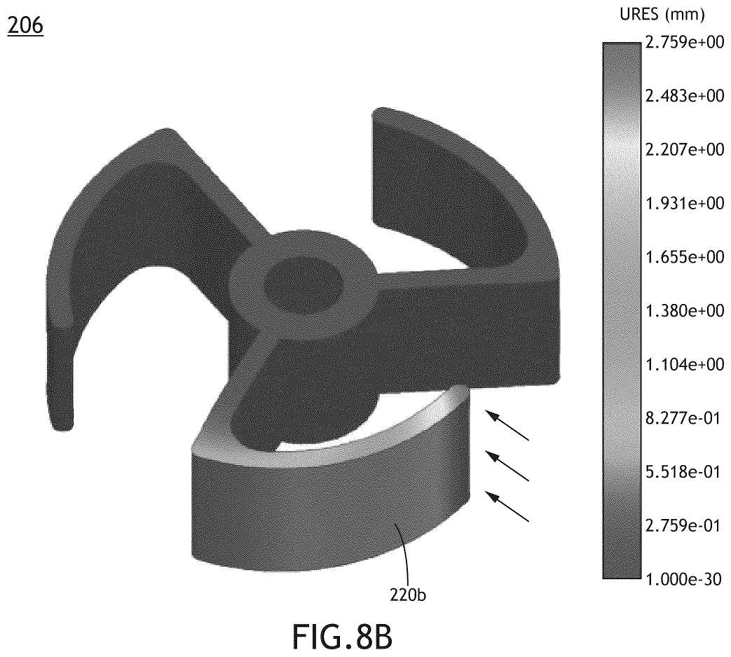

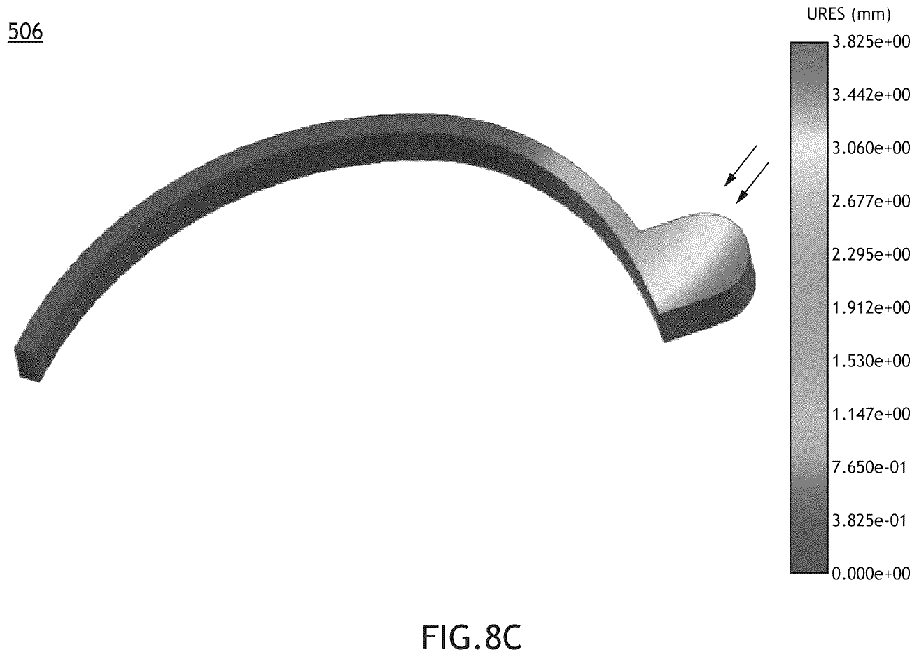

FIGS. 8A-8C illustrates simulations of the compliant members, in accordance with one or more embodiments of the present disclosure. The simulations are generated from finite element analysis. Five possible cases were studied at differing stiffness settings of the respective mechanisms. The displaced shapes shown are exaggerated. In each simulation a load of 22N (5 lbs) was placed at the point of contact between the compliant member and the second unit. From the resulting displacements, the effective spring stiffnesses were calculated. The material for each of the compliant components was Nylon 6/10 with an elastic modulus of 830 MPa. This material was selected as its elasticity was closest to the PAHT-CF material used to additively manufacture the variable-stiffness mechanism prototypes.

For the variable-stiffness mechanisms 102 with the spiral-shaped arc-segment portions 220a and the circular-shaped arc-segment portions 220b, five different stiffnesses were analyzed by placing the load at 5 evenly distributed points along the beams. The only constraint necessary in these simulations was a fixture applied in the inner-annular portion 216. While the largest displacement occurred at the tip of the beam, it was the point at which the load was applied that was measured, consistent with the objective of regulating effective end-effector behavior.

Due to the limited effectiveness indicated by the graph 700, finite element analysis was not pursued for the variable-stiffness mechanism 400.

For the variable-stiffness mechanism 500 configured as the gear-slider, the load was applied at the edge of contact located at the contact portions 522. Two fixture constraints were placed in the locations of the coupling between the compliant members 506 and the ring-gear segments 514. As described, the variable-stiffness mechanism 500 changes the effective beam length by sliding revolving the compliant members 506 about the sun gear 508 thereby changing the position of the pivot pins 518 along the compliant members 506. To mirror the effect of the pivot pins 518, an additional roller constraint was positioned in 5 differing locations along the inside radius of the compliant members 506. This was how each of the 5 cases were rendered.

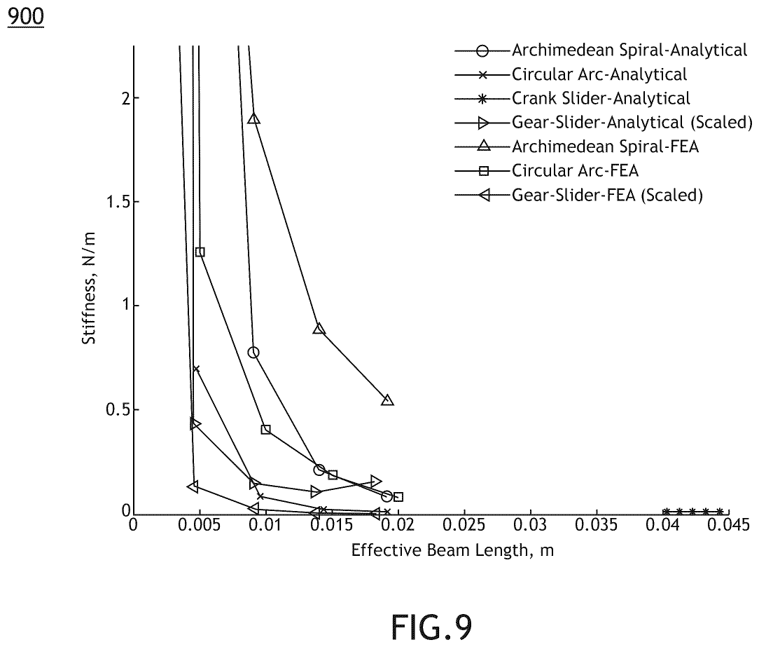

FIG. 9 illustrates a graph 900, in accordance with one or more embodiments of the present disclosure. The graph 900 depicts stiffness in newtons per meter as a function of the effective beam length in meters. The graph 900 provides a comparison of the finite-element analysis and the analytical results. For effective beam lengths near zero, the stiffness approaches infinity asymptotically. As the lengths increase, the stiffness further decreases as expected. Although the analytical and finite-element analysis differ slightly, the general trends appear to match.

Between the variable-stiffness mechanisms 102 with the spiral-shaped arc-segment portions 220a and the circular-shaped arc-segment portions 220b, the spiral-shaped arc-segment portions 220a has higher stiffness. The higher stiffness could be for a few reasons, but is suspected to be caused by the larger thickness of the spiral-shaped arc-segment portions 220a. However, the range of achievable stiffnesses is similar, lending to the idea that both are viable designs.

Observing the bottom right of the graph 900, the range of stiffness for the variable-stiffness mechanism 400 not only offers the smallest range of stiffness variation but also does not offer the potential for infinite stiffness. For these reasons, the variable-stiffness mechanism 400 may or may not be a suitable design depending upon the desired stiffness characteristics.

According to the finite-element analysis for the variable-stiffness mechanism 500, the variable-stiffness mechanism 500 may provide the greatest range of stiffness variation compared to the other mechanisms. However, the slope for transitioning between stiffness remains rather flat until reaching a maximum stiffness setting. This result is plausible with the beam's extended range of motion compared to the mechanisms. According to the analytical results, the stiffness range still spans the other mechanisms, except for the circular-shaped arc-segment portions 220b. Another important mention is the slight increase in stiffness at the beam's longest effective length. It is not apparent if this correctly reflects the true nature of the mechanism or if this results from its atypical constraints. Therefore, further testing of the variable-stiffness mechanism 500 is warranted.

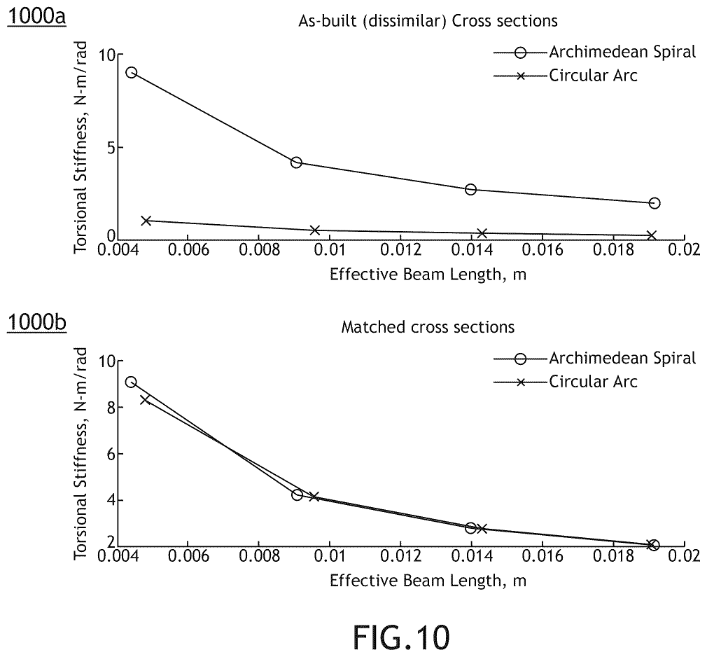

FIG. 10 illustrates graphs 1000, in accordance with one or more embodiments of the present disclosure. The graphs 1000 may depict torsional stiffness in newton meters per radian as a function of effective beam length in meters. The graphs 1000 include a graph 1000a and a graph 1000b.

The graph 1000a is for the as-built cross-sections of the spiral-shaped arc-segment portions 220a and the circular-shaped arc-segment portions 220b.

The graph 1000b is for the matched cross-sections of the spiral-shaped arc-segment portions 220a and the circular-shaped arc-segment portions 220b. The cross-sections are matched to normalize the results for the spiral-shaped arc-segment portions 220a and the circular-shaped arc-segment portions 220b. With identical cross sections, there is little difference in the achievable stiffnesses. This shows that the added preload effect active in the spiral-shaped arc-segment portions 220a may be independent of the stiffness. It should also be noted that with the increasing radius in the spiral-shaped arc-segment portions 220a, there is less room to expand the range of stiffness compared to the circular-shaped arc-segment portions 220b without encountering interference between the components. Thus, there exists a tradeoff in these designs between an extended range of stiffness and added preload effect.

From the above observations, the variable-stiffness mechanism 102 with the spiral-shaped arc-segment portions 220a and the circular-shaped arc-segment portions 220b and the variable-stiffness mechanism 500 are determined to provide variable stiffness.

Referring generally again to the figures.

It is contemplated that the system 100 and/or the variable-stiffness mechanisms may be used in a variety of applications. For example, the system 100 and/or the variable-stiffness mechanisms may be used in robotics (e.g., industrial robots, pick-and-place robots, soft robotics, humanoid robots, professional service robots with human interaction), professional service robots, manufacturing, agricultural robots, dynamic vehicle suspension systems, rovers, automotive applications (e.g., dynamic vehicle suspension), and the like. The integration of variable mechanical properties, particularly variable stiffness, is of interest in view of a variety of applications in which such tunable properties could become advantageous. Potential advantages include the ability to tailor dynamic behavior of manipulators and customize interactions with the environment. Benefits include reduced mechanical complexity, passive operation, and/or cost.

Although the arc-segment portions 220 are described as extending circumferentially from the inner-connecting portions 218 with either a clockwise handedness or a counter-clockwise handedness, this is not intended as a limitation of the present disclosure. It is contemplated that the arc-segment portions 220 may extend circumferentially in each direction from the inner-connecting portions 218. Extending the arc-segment portions 220 circumferentially in each direction from the inner-connecting portions 218 may increase a length of contact between the second unit 204 and the compliant member 206, thereby increasing an angle by which the second unit 204 is configured to rotate relative to the first unit 202 and/or the compliant member 206 and/or providing bi-directional stiffness.

As used herein, the term “axial” and derivatives thereof, such as “axially,” shall be understood to refer to a direction along the axis configured to rotate in operation of the apparatus described herein. The term “coaxial” shall be understood to refer to rotatable about a common axis. Further, the term “radial” and derivatives thereof, such as “radially,” shall be understood in relation to the axis of the axis. For example, “radially outward” refers to further away from the axis, while “radially inward” refers to nearer to the axis.

It is further contemplated that each of the embodiments of the method described above may include any other step(s) of any other method(s) described herein. In addition, each of the embodiments of the method described above may be performed by any of the systems described herein.

One skilled in the art will recognize that the herein described components operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, operations, devices, and objects should not be taken as limiting.

As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mixable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A variable-stiffness mechanism comprising:
a first unit;
a second unit, wherein the second unit comprises an outer-annular portion and a plurality of contact portions, wherein the plurality of contact portions are disposed radially inwards of and axially aligned with the outer-annular portion; and
a compliant member, wherein the compliant member is fixed to the first unit, wherein the compliant member is disposed radially inwards of and axially aligned with the second unit, wherein the compliant member comprises a plurality of arc-segment portions, wherein the plurality of arc-segment portions are cantilever beams, wherein the plurality of contact portions abut the plurality of arc-segment portions, wherein the second unit is configured to rotate relative to the first unit and the compliant member, wherein the plurality of contact portions maintain abutment with the plurality of arc-segment portions as the second unit rotates relative to the first unit and the compliant member, wherein a stiffness of the variable-stiffness mechanism is varied based on a circumferential position at which the plurality of contact portions abut the plurality of arc-segment portions.

2. The variable-stiffness mechanism of claim 1, wherein the compliant member comprises a plurality of inner-connecting portions, wherein the plurality of inner-connecting portions extend radially inwards from the plurality of arc-segment portions, wherein the plurality of arc-segment portions cantilever circumferentially from the plurality of inner-connecting portions.

3. The variable-stiffness mechanism of claim 2, wherein the plurality of arc-segment portions include supported ends and unsupported ends, wherein the supported ends are circumferentially aligned with and supported by the plurality of inner-connecting portions, wherein the stiffness is lowest when the plurality of contact portions abut the unsupported ends and highest when the plurality of contact portions abut the supported ends.

4. The variable-stiffness mechanism of claim 3, wherein the plurality of arc-segment portions are spiral-shaped arc-segment portions, wherein the supported ends are disposed radially inwards of the unsupported ends.

5. The variable-stiffness mechanism of claim 3, wherein the plurality of arc-segment portions are circular-shaped arc-segment portions, wherein the supported ends are radially aligned with the unsupported ends.

6. The variable-stiffness mechanism of claim 2, wherein the compliant member comprises an inner-annular portion, wherein the plurality of inner-connecting portions extend radially outwards from the inner-annular portion, wherein the inner-annular portion is fixed to the first unit.

7. The variable-stiffness mechanism of claim 1, wherein the second unit comprises a plurality of outer-connecting portions, wherein the plurality of outer-connecting portions are radially disposed between and connect the plurality of contact portions with the outer-annular portion, wherein the plurality of contact portions are configured to flex relative to the outer-annular portion via the plurality of outer-connecting portions.

8. The variable-stiffness mechanism of claim 7, wherein pairs of the plurality of outer-connecting portions connect the plurality of contact portions with the outer-annular portion and are separated by a gap distance.

9. The variable-stiffness mechanism of claim 1, wherein the plurality of contact portions comprise a rounded-trapezoid shape.

10. A variable-stiffness mechanism comprising:
a first unit, wherein the first unit defines a plurality of slotted arcs;
a second unit, wherein the second unit is configured to rotate relative to the first unit; and
a plurality of crank-slider subassemblies, wherein the second unit is disposed radially inwards of and axially aligned with the plurality of crank-slider subassemblies, wherein the plurality of crank-slider subassemblies comprise:
a compliant member, wherein the compliant member abuts the second unit;
an input crank, wherein the input crank is coupled to the first unit by a revolute joint;
a pair of connecting rods;
a pair of rod-to-member revolute joints, wherein the compliant member is coupled to the pair of connecting rods by the pair of rod-to-member revolute joints; and
a pair of crank-to-rod revolute joints, wherein the pair of connecting rods are coupled to the input crank by the pair of crank-to-rod revolute joints, wherein the pair of crank-to-rod revolute joints are configured to follow within the plurality of slotted arcs, wherein a circumferential center of the compliant member to which the second unit abuts is configured to flex radially inwards and outwards as the pair of crank-to-rod revolute joints follow within the plurality of slotted arcs, wherein a stiffness of the variable-stiffness mechanism is varied based on flexure of the compliant member.

11. The variable-stiffness mechanism of claim 10, wherein the stiffness is variable by rotating the input crank relative to the first unit.

12. The variable-stiffness mechanism of claim 10, wherein the compliant member is configured to flex radially inwards to increase the stiffness and radially outwards to decrease the stiffness.

13. The variable-stiffness mechanism of claim 10, wherein axes of rotation of the pair of rod-to-member revolute joints and the pair of crank-to-rod revolute joints are parallel.

14. A variable-stiffness mechanism comprising:
a first unit;
a second unit, wherein the second unit is configured to rotate relative to the first unit, wherein the second unit is annular;
a planetary gearset, wherein the planetary gearset is disposed radially inwards of and axially aligned with the second unit, wherein the planetary gearset comprises:
a sun gear, wherein the sun gear is configured to rotate relative to the first unit;
a plurality of planet gears, wherein the plurality of planet gears are coupled to the first unit by a plurality of unit-to-planet revolute joints, wherein the sun gear engages with the plurality of planet gears;
a plurality of ring-gear segments, wherein the plurality of planet gears engage with respective of the plurality of ring-gear segments; and
a plurality of compliant members, wherein the plurality of compliant members are coupled to and revolve with respective of the plurality of ring-gear segments about the sun gear, wherein the plurality of compliant members comprise:
an arc-segment portion, wherein the arc-segment portion couples to the plurality of ring-gear segments; and
a contact portion, wherein the contact portion extends radially from the arc-segment portion and abuts the second unit; and
a plurality of pivot pins fixed to the first unit, wherein the plurality of pivot pins and the plurality of ring-gear segments are radially aligned, wherein the arc-segment portion of the plurality of compliant members abut and pivot about the plurality of pivot pins, wherein a stiffness of the variable-stiffness mechanism is varied based on a circumferential position at which the plurality of pivot pins abut the arc-segment portion of the plurality of compliant members.

15. The variable-stiffness mechanism of claim 14, wherein the sun gear is configured to adjust the stiffness by rotating the plurality of planet gears causing the plurality of ring-gear segments and the plurality of compliant members to revolve about the sun gear.

16. The variable-stiffness mechanism of claim 14, wherein the plurality of ring-gear segments are disconnected.

17. The variable-stiffness mechanism of claim 14, wherein the plurality of ring-gear segments are connected by a plurality of connecting segments, wherein the plurality of ring-gear segments and the plurality of connecting segments form a ring gear.

18. The variable-stiffness mechanism of claim 17, wherein the plurality of connecting segments are disposed radially inwards of and circumferentially aligned with the plurality of pivot pins.

19. The variable-stiffness mechanism of claim 14, comprising a plurality of ring guides fixed to the first unit, wherein the plurality of ring guides and the plurality of ring-gear segments are radially aligned, wherein the plurality of ring-gear segments define a plurality of slotted arcs, wherein the plurality of slotted arcs are circular cams within which the plurality of ring guides are configured to follow.

20. The variable-stiffness mechanism of claim 14, wherein the contact portion comprises a rounded-trapezoid shape.
